(19) United States
(12) Patent Application Publication
(10) Pub. No.: US 2004/0136180 A1
(43) Pub. Date: Jul. 15, 2004

(54) Ultraviolet illuminated fluorescent writing instrument

(76) Inventors: Edward D. Lewis, Brownsburg, IN (US); Daniel J. Deutsch, Orlando, FL (US)

Correspondence Address: BAHRET & ASSOCIATES, 320 NORTH MERIDIAN STREET, SUITE 512, INDIANAPOLIS, IN, 46204, US

(21) Appl. No.: 10/341,325

(22) Filed: Jan. 13, 2003

(51) Int. Cl. B43K 29/10

(52) U.S. Cl. 362/118

(57) ABSTRACT

An illuminated writing instrument including a barrel having fluorescent pigment illuminated by a UV LED. An electrical power source such as a button cell and an electrical switch are electrically connected to the UV LED for selectively controlling the flow of electrical current between the power source and the LED. An upper housing connected to the barrel contains the power source, the electrical switch, and the UV LED. The fluorescent pigment of the barrel emits visible light in response to ultraviolet light.

### BACKGROUND OF THE INVENTION

The present invention relates generally to writing instruments such as pens and pencils, and relates more particularly to writing instruments having a self-contained source of illumination.

It is known to provide a writing instrument, such as a pen or mechanical pencil, with a self-contained source of illumination to light the writing surface while writing in the dark or to provide decorative, aesthetic or informational features. Lighted pens commonly include a lamp of the light-emitting diode (LED) or incandescent type, a battery, and an electrical switch to control the flow of current between the battery and the lamp.

To help disperse or direct the light, the barrel of the pen may be comprised of a transparent or translucent material that serves as a waveguide for the light emitted from the lamp that is disposed somewhere within the body of the pen. The illuminated barrel can back light a design, logo, message, advertisement or other marking on the pen, or otherwise create a decorative or aesthetically pleasing lighted effect.

### SUMMARY OF THE INVENTION

The present invention provides an illuminated writing instrument having a writing element and including a barrel having fluorescent pigment illuminated by a UV LED. The writing instrument further includes an electrical power source and an electrical switch for selectively controlling the flow of electrical current between the power source and the LED.

Another aspect of the present invention involves an illuminated wand with a UV LED and fluorescent pigment.

Other aspects of the present invention will be apparent from the following description of preferred embodiments with reference to the accompanying drawings.

### BRIEF DESCRIPTION OF THE DRAWINGS

FIG. 1 is a front elevational view, partially in section, of an embodiment of an illuminated writing instrument according to the present invention.

FIG. 2 is a side elevational view of an embodiment of an illuminated wand according to the present invention.

FIG. 3 is a side elevational view of an alternative embodiment of an illuminated wand according to the present invention.

FIG. 4 is an end view of the barrel portion of the illuminated wand of FIG. 3, from the upper or housing end of the barrel, showing the hexagonal internal cross-section and the stepwise change in internal cross-sectional dimensions.

### DETAILED DESCRIPTION OF THE PREFERRED EMBODIMENTS

For the purposes of promoting an understanding of the principles of the invention, reference will now be made to the embodiments illustrated in the drawings and specific language will be used to describe the same. It will nevertheless be understood that no limitation of the scope of the invention is thereby intended, such alterations and further modifications in the illustrated device, and such further applications of the principles of the invention as illustrated therein being contemplated as would normally occur to one skilled in the art to which the invention relates.

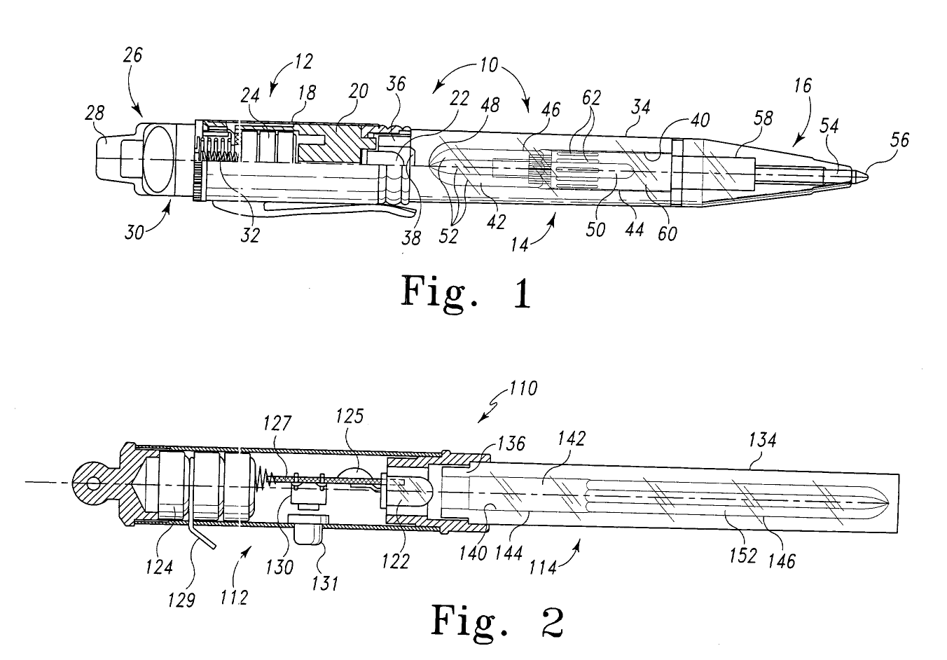

Referring to FIG. 1, the present invention provides a hand-held writing instrument that, in a preferred embodiment, comprises a ballpoint ink pen 10. The principal components of pen 10 include an upper housing 12, a barrel 14 and a tapered tip 16. Barrel 14 and tapered tip 16 are constructed of a transparent or translucent molded plastic material and are illuminated by a light source within upper housing 12. As preferred, the plastic material of barrel 14 and tapered tip 16 have fluorescent pigment mixed therein prior to molding. In an alternative configuration that may be desirable for some applications, the fluorescent pigment may be applied as a coating to the inner or outer surfaces of the barrel 14. The light source within upper housing 12 is a UV LED. The ultraviolet light excites the fluorescent pigment and causes the barrel 14 and tapered tip 16 to glow, creating a novel and pleasing aesthetic effect, and also illuminating the writing surface to facilitate writing in low-light conditions.

Upper housing 12 includes a metal hollow body 18 having a plastic insulator 20 disposed therein, the insulator 20 supporting a UV LED 22 at the lower end thereof, and receiving a plurality of stacked button-cells 24 in an upper end thereof, e.g., three AG10 cells connected in series. One lead of the UV LED 22 is electrically connected to the lower end of the stack of button-cells 24, and the other lead of the UV LED 22 is electrically connected to the metal hollow body 18. Upper housing 12 further includes a metal switch housing 26 having a thumb actuated plunger 28 that activates a push-on, push-off single throw electrical switch 30 disposed therein. One pole of switch 30 is electrically connected to metal switch housing 26 and the other pole of switch 30 is electrically connected to an axial coil spring 32 that alternately extends into and withdraws from contact with the upper button-cell 24 as plunger 28 is actuated. Metal switch housing 26 is electrically and mechanically connected to metal hollow body 18. Consequently, the electrical circuit is completed by switch 30 when the axial coil spring 32 contacts the button-cells 24, causing current to flow through UV LED 22 and resulting in ultraviolet light being emitted therefrom. Preferably, UV LED 22 emits light having a wavelength in the range of about 390 to about 410 nm, more preferably having a peak of about 390 nm to about 410 nm, and most preferably having a peak of about 400 nm. A suitable UV LED is the DL50PLDW503 UV LED available from Shue Kwong Optic Electronic Company, Shenzhen, China.

Barrel 14 has a substantially cylindrical or slightly tapered outer surface 34, and includes an externally threaded upper terminal portion 36 for threadedly engaging internal threads at the lower end of the upper housing 12 to mechanically connect the barrel 14 to the upper housing 12. Upper terminal portion 36 includes an axial recess 38 to provide clearance for receipt of UV LED 22 therein. Barrel 14 has an inner surface 40 defining a hollow space 42 that is closed at the upper end and is open at the lower end of barrel 14. Inner surface 40 includes a lower first portion 44 that is substantially cylindrical and an upper second portion 46 that tapers upwardly at a variable taper to converge at an upper point 48. First portion 44 has a plurality of longitudinal ribs 50 that extend radially inwardly to provide a friction fit with an adjoining component received in hollow space 42, as described below. Second portion 46 has a plurality of longitudinal facets 52 that serve to reflect and disperse the ultraviolet light so that it is transmitted throughout the plastic material along the length of barrel 14. The intensity of the illumination diminishes somewhat along the length of the barrel 14, due to increased attenuation of the ultraviolet light as it passes through the plastic material. This results in the brightness of the visible light emitted from barrel 14 diminishing over the length of barrel 14 toward the tapered tip 16, with a point of concentrated light occurring in the vicinity of upper point 48.

Tapered tip 16 includes an elongate marking element, namely an ink cartridge 54 with integral ballpoint 56, that is connected to a twist extension mechanism 58 embedded within the plastic material of tapered tip 16. Extension mechanism 58 includes a shaft 60 having a plurality of longitudinal flutes 62 that extend into hollow space 42. The flutes 62 frictionally engage the ribs 50 of the first portion 44 of inner surface 40 such that shaft 60 remains static relative to barrel 14 as tapered tip 16 is rotated relative to barrel 14. Such rotation results in the alternating extension and retraction of ballpoint 56 from tapered tip 16. The plastic material of tapered tip 16 abuts the plastic material of barrel 14, allowing for transmission of ultraviolet light from barrel 14 to tapered tip 16.

The plastic material of barrel 14 and tapered tip 16 can be a polycarbonate material that is mixed with fluorescent pigment and injection molded into the shapes of barrel 14 and tapered tip 16. Alternatively, the plastic material may be polystyrene, PVC, ABS or acrylic materials. The pigment may be mixed at a ratio of about 1 to 2 grams of pigment per kilogram of plastic material. The fluorescent pigment may be a pigment that is commercially available from Wen Lee Plastic Pigment Company, Tungguong, China, such as Part No. 61113 (green), Part No. 31461 (blue), Part No. 238 (red), or Part No. 2600 (yellow).

Referring to FIG. 2, there is illustrated an alternative embodiment of the present invention in the form of a light wand 110. Light wand 110 does not include a writing element as shown but may be so modified if desired. The principal components of wand 1 10 include an upper housing 112 and a barrel 114. Barrel 114 is constructed of a transparent or translucent molded plastic material having fluorescent pigments mixed therein prior to molding and is illuminated by a UV LED 122 within upper housing 112. UV LED 122 is preferably the same type as LED 22 described above. Similar to writing instrument 10, light wand 110 includes stacked button-cells 124 in an upper end thereof and an electrical switch 130 with an associated pushbutton 131 to cause current to flow through the UV LED. The switch may be connected directly in series with the LED and button cells, but in the disclosed embodiment an integrated circuit (IC) die 125 is wire bonded to a printed circuit board 127 on which the switch and LED are mounted. IC 125 may be an AP3761-03 IC from Advanced Microelectronic Products, Inc., Taiwan, and may have switch 130 connected to a control input thereof and LED 122 connected to an output thereof. The IC may be configured to operate in repetitive flash mode when the switch is closed, with a ⅓ duty cycle for the LED and at a flash rate of about 7 flashes per second, for example. The flashing of the LED results in ultraviolet light being emitted therefrom so as to excited the fluorescent pigment and cause the barrel to glow. A pull tab 129 may be provided between button cells as shown to maintain an open circuit during shipment and prior to sale and thereby prevent inadvertent circuit activation and consequent battery drain. The pull tab is inserted during assembly through a hole provided in the sidewall of housing 112 and is removed therefrom when it is desired to enable operation of the circuit.

Barrel 114 has a substantially cylindrical or slightly tapered outer surface 134, and may include an externally threaded upper terminal portion 136 for threadedly engaging internal threads at the lower end of the upper housing 112 to mechanically connect the barrel 114 to the upper housing 112. Barrel 114 has an inner surface 14() defining a hollow space 142 that is closed at the lower end and is open at the upper end of barrel 114 to receive UV LED 122 therein. Inner surface 140 includes an upper first portion 144 that is substantially cylindrical and a lower second portion 146 that tapers downwardly at a variable taper to converge at a lower point 148. Second portion 146 has a plurality of longitudinal facets 152 that serve to collect the ultraviolet light that travels through the hollow space 142 and reflect and refract the ultraviolet light throughout the plastic material of barrel 114. Because the hollow space 142 runs substantially the length of barrel 114, the ultraviolet light is transmitted mostly through air over the length of the barrel 114, resulting in minimal attenuation. Consequently, inner surface 140 and facets 152 of barrel 114 are substantially evenly illuminated by ultraviolet light over their length. This results in a fairly even emission of visible light along the length of barrel 114, except for a point of concentrated light at the lower point 148 where the facets 152 converge, providing a particularly pleasing aesthetic effect. The plastic material of barrel 114 can be any of the materials discussed above with respect to barrel 14 of writing instrument 10, and the pigment may be any of the pigments discussed above mixed into or coated on the plastic material.

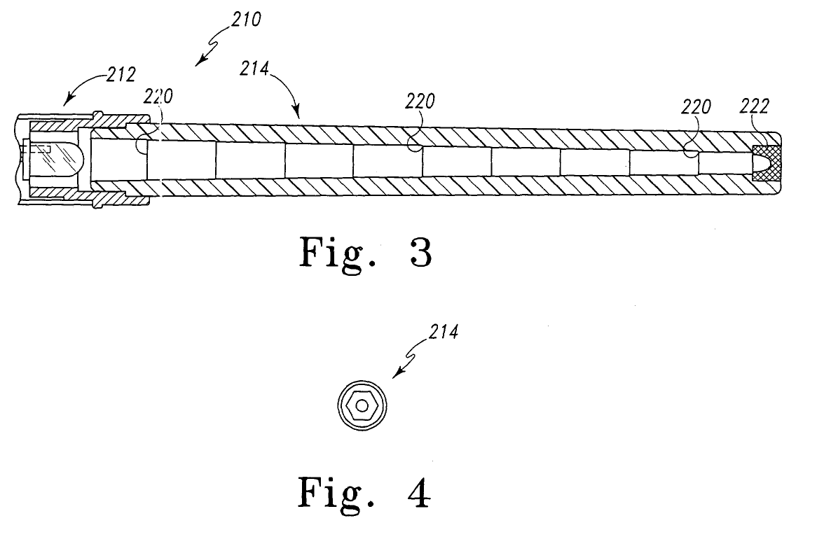

FIG. 3 shows an alterative embodiment of a light wand 210 in which the upper housing 212 may be the same as housing 112 described above but the barrel 214 reduces diameter in steps toward the tip thereof, producing a number of edges or rings 220 which, due to the sudden change in diameter, catch the light from the LED and refract it outwardly. The visible effect is of a number of bright light rings along the length of a glowing wand barrel, with otherwise relatively evenly distributed light emission along the barrel length. The light wand preferably has a flasher circuit as described above with respect to FIG. 2, and appears to pulsate with traveling waves of light moving from the LED to the barrel tip, with some reflection back toward the LED. An insert 222 at the tip may have a smooth curved inside surface as shown in FIG. 3 or may have a faceted inside surface to cause discrete changes in the angle of internal reflection at the tip.

Wand 210 preferably includes the same type of UV LED and fluorescent pigment as in the other embodiments, and, with a 400 nm UV LED and fluorescent green pigment, for example, the wand produces rings of light as described above, with a blue cast visible at edges 220 and elsewhere along the barrel from some but not all viewing angles. The barrel may have a circular internal cross-section at each point along its length or may have a hexagonal cross-section as shown in FIG. 4 at various points along its length. The barrel may, as one example of dimensions, have a stepwise change in internal diameter every 10 mm, an overall length of 100 mm, and internal and external taper angles as drawn to scale in FIG. 3. The stepwise change in diameter, i.e., the transition from one diameter to another inside the barrel, may occur over an axial length of approximately 0.1 mm. The barrel material may be the same as in the other embodiments described above.

While the invention has been illustrated and described in detail in the drawings and foregoing description, the same is to be considered as illustrative and not restrictive in character, it being understood that only the preferred embodiment has been shown and described and that all changes and modifications that come within the spirit of the invention are desired to be protected. For example, it is also contemplated that fluorescein dye may be mixed with ink to be applied to a surface of the barrel of the pen or wand to form a logo or other indicia desired to be illuminated.

What is claimed is:

1. An illuminated writing instrument, comprising:
a barrel having fluorescent pigment;
a writing element connected to the barrel;
an ultraviolet light-emitting diode proximate the barrel to illuminate the fluorescent pigment;
an electrical power source; and
an electrical switch for selectively controlling the flow of electrical current between the power source and light-emitting diode.

2. The writing instrument of claim 1, further including an upper housing connected to the barrel, the upper housing containing the electrical power source and the electrical switch.

3. The writing instrument of claim 2, wherein the upper housing contains the ultraviolet light-emitting diode.

4. The writing instrument of claim 1, wherein the fluorescent pigment of the barrel emits visible light in response to being illuminated by ultraviolet light from the light-emitting diode.

5. The writing instrument of claim 1, wherein the ultraviolet light-emitting diode emits light having a peak wavelength in the range of about 390 nm to about 410 nm.

6. The writing instrument of claim 5, wherein the ultraviolet light-emitting diode emits light having a peak wavelength of about 400 nm.

7. An illuminated wand, comprising:
a barrel having fluorescent pigment;
an ultraviolet light-emitting diode proximate the barrel to illuminate the fluorescent pigment;
an electrical power source; and
an electrical switch for selectively controlling the flow of electrical current between the power source and light-emitting diode.

8. The illuminated wand of claim 7, wherein the fluorescent pigment of the barrel emits visible light in response to being illuminated by ultraviolet light from the light-emitting diode.

9. The illuminated wand of claim 7, wherein the ultraviolet light-emitting diode emits light having a peak wavelength in the range of about 390 nm to about 410 nm.

10. The illuminated wand of claim 1, wherein the barrel has a longitudinal hollow space defined by an inner surface running substantially the length of the barrel, substantially the entire inner surface being illuminated by ultraviolet light passing through the hollow space.
